(19) United States
(12) Patent Application Publication
(10) Pub. No.: US 2026/0270019 A1
(43) Pub. Date: Sep. 10, 2026

(54) BUFFER STATUS REPORT POLE (BSRP) TRIGGER ENHANCEMENT TO QUERY SPECIFIC FEEDBACK

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(21) Appl. No.: 19/557,843

(22) Filed: Mar. 5, 2026

Related U.S. Application Data
(60) Provisional application No. 63/795,824, filed on Apr. 28, 2025.
(60) Provisional application No. 63/767,418, filed on Mar. 5, 2025.

(51) Int. Cl. H04L 5/00; H04L 1/1812; H04W 28/02

(52) U.S. Cl. CPC H04L 5/0053; H04L 1/1812; H04W 28/0278

(57) ABSTRACT

Buffer Status Report Pole (BSRP) trigger enhancement to query specific feedback may be provided. An initiator Access Point (AP) may send a trigger frame wherein the trigger frame comprises a feedback indicator. Next a receiving device may send a Multi-Station Block Acknowledge (Multi-STA BA) in response to the trigger frame wherein feedback information is included in the Multi-STA BA in response to the trigger frame comprising the feedback indicator. Then the initiator AP may receive the feedback information in the Multi-STA BA.

### RELATED APPLICATION

Under provisions of 35 U.S.C. § 119(e), Applicant claims the benefit of U.S. Provisional Application No. 63/767,418, filed Mar. 5, 2025, which is incorporated herein by reference. Under provisions of 35 U.S.C. § 119(e), Applicant claims the benefit of U.S. Provisional Application No. 63/795,824, filed Apr. 28, 2025, which is incorporated herein by reference.

### TECHNICAL FIELD

The present disclosure relates generally to providing Buffer Status Report Pole (BSRP) trigger enhancement to query specific feedback.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Buffer Status Report Pole (BSRP) trigger enhancement to query specific feedback;

FIG. 2 is a flow chart of a method for providing BSRP trigger enhancement to query specific feedback; and

FIG. 3 is a block diagram of a computing device.

### DETAILED DESCRIPTION

### OVERVIEW

Buffer Status Report Pole (BSRP) trigger enhancement to query specific feedback may be provided. An initiator Access Point (AP) may send a trigger frame wherein the trigger frame comprises a feedback indicator. Next a receiving device may send a Multi-Station Block Acknowledge (Multi-STA BA) in response to the trigger frame wherein feedback information is included in the Multi-STA BA in response to the trigger frame comprising the feedback indicator. Then the initiator AP may receive the feedback information in the Multi-STA BA.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A Buffer Status Report Pole (BSRP) trigger frame or a BSRP non-trigger based (NTB) trigger frame may be used as an Initial Control Frame (ICF) in many features (e.g., Dynamic Unavailability Operation (DUO), Dynamic Packet State (DPS), Dynamic Sub-Band Operation (DSO), Coordinated Time Division Multiple Access (Co-TDMA (Co-TDMA) etc.). When an AP is using a BSRP trigger frame or a BSRP NTB trigger frame as an ICF, in some cases it may not be asking for a Buffer Status Report (BSR) to be reported. In other cases, when the AP sends a BSRP, it may be asking for a BSR to be reported by the client devices (i.e., Stations (STAs)). Given BSRP trigger frame usage has been extended for Ultra High Reliability (UHR), it may be desirable for an AP to explicitly signal in the BSRP trigger frame or in the BSRP NTB trigger frame if it is requesting BSR information to be sent in response to the BSRP trigger in an Initial Control Response (ICR) frame such as a Multi-Station Block Acknowledgement (Multi-STA BA) frame.

Embodiments of the disclosure may provide a BSRP trigger signaling enhancement for an AP to explicitly signal to STAs (or to another AP) that it is requesting feedback and the specific types of requested feedback (e.g., BSR, Delay Feedback, Low-Latency Indication (LLI) feedback, etc.) in a response Multi-STA BA frame. This may enable an AP to receive timely traffic related feedback for it to perform more effective Uplink (UL) scheduling or Transmission Opportunity (TxOP) sharing (e.g., in the case of Coordinated Time Division Multiple Access (Co-TDMA)). In case of a Co-TDMA, an AP may request in the BSRP trigger frame or in the BSRP NTB trigger frame that the polled AP responds with specific feedback information (e.g., request polled AP to provide details for Co-TDMA feedback type.

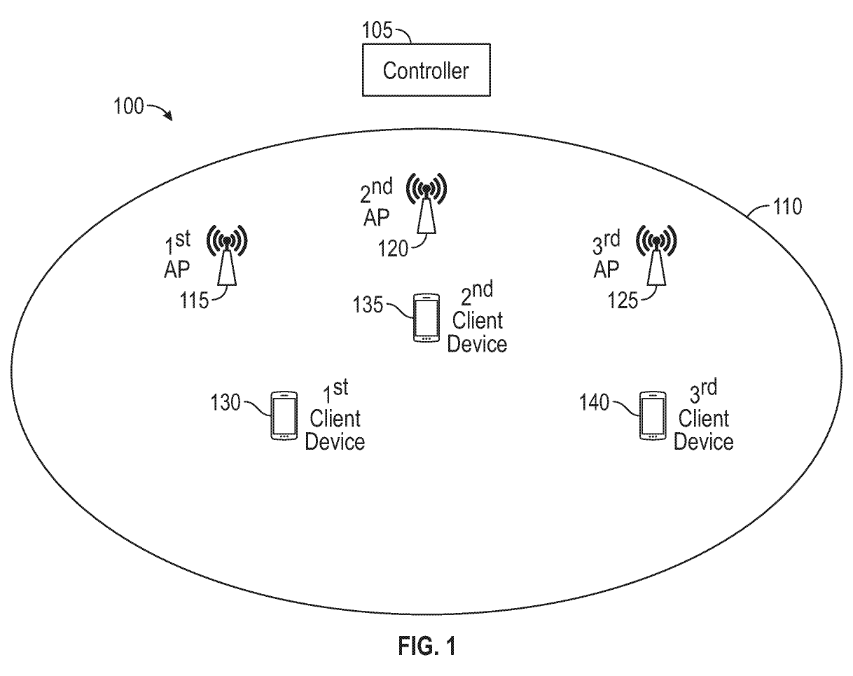

FIG. 1 shows an operating environment 100 for providing Buffer Status Report Pole (BSRP) trigger enhancement to query specific feedback. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide BSRP trigger enhancement to query specific feedback.

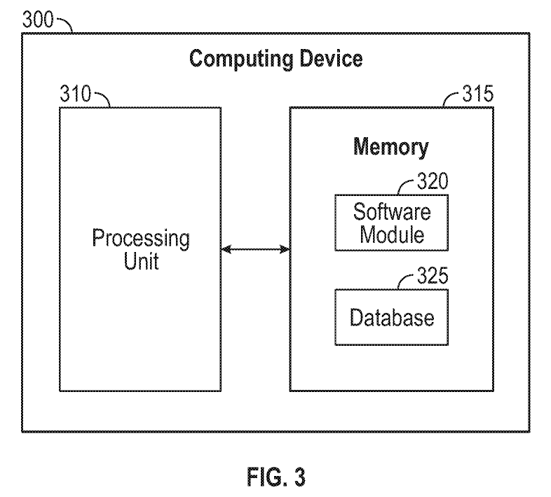

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

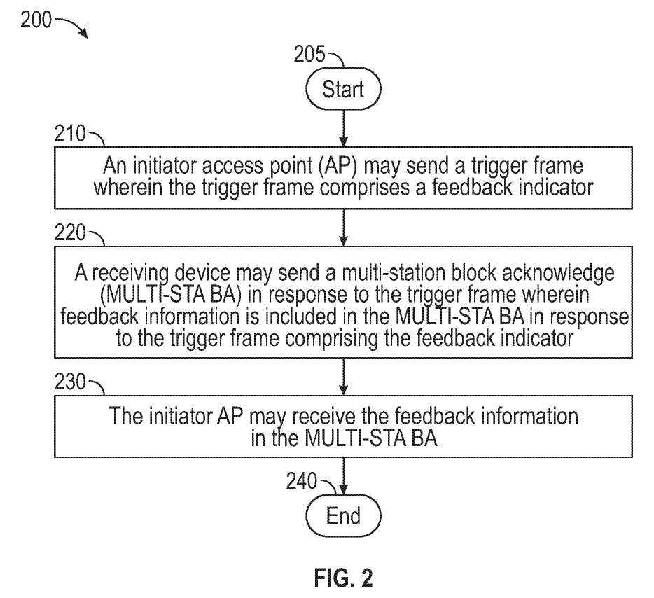

FIG. 2 is a flow chart setting forth the general stages involved in a method 200 consistent with embodiments of the disclosure for providing Buffer Status Report Pole (BSRP) trigger enhancement to query specific feedback. Method 200 may be implemented using a computing device 300 as described in more detail below with respect to FIG. 3. Ways to implement the stages of method 200 will be described in greater detail below.

Method 200 may begin at starting block 205 and proceed to stage 210 where an initiator AP (e.g., first AP 115) may send a trigger frame wherein the trigger frame comprises a feedback indicator. For example, the trigger frame may comprise, but is not limited to, a Buffer Status Report Pole (BSRP) trigger frame or a Buffer Status Report Pole (BSRP) Non-Trigger Based (NTB) trigger frame. Given BSRP usage has been extended for UHR, it may be desirable for the initiator AP to explicitly signal in the trigger frame if it is requesting BSR information and/or delay feedback (or any other feedback types such as LLI feedback, Co-TDMA feedback, etc. as described in greater detail below) to be sent in response to the trigger frame. Embodiments of the disclosure may define a way for the initiator AP to signal explicitly that it is requesting for BSR and/or delay feedback information or other types of feedback information in response to the BSRP trigger frame or BSRP NTB trigger frame. This may be applicable for the case when an AP is sending a BSRP trigger frame or BSRP NTB trigger frame to non-AP STAs (e.g., client devices) as well as for a Co-TDMA case where a sharing AP is sending a BRSP trigger frame or a BSRP NTB trigger frame to poll one or more other APs (i.e., polled APs).

The following describes example ways the feedback indicator may be signaled in the trigger frame. In a first example, a request (e.g., the feedback indicator) from the initiator AP may be signaled in the Common Information (Common Info) field in a BSRP (NTB) trigger frame (e.g., using a reserved bit or a repurposed bit), if this request for feedback information (BSR, Delay Feedback, LLI feedback, Co-TDMA feedback, and/or other feedback) applies for all STAs for which User Information fields are included in the BSRP trigger frame. In a second example, a request from the initiator AP may be signaled in the User Information (User Info) field in a BSRP (NTB) Trigger frame (e.g., using a reserved bit or a repurposed bit), if this request for feedback information (e.g., BSR, Delay Feedback, LLI feedback, Co-TDMA feedback and/or other feedback) is specific to a STA in the BSRP trigger frame. Reserved bits may be used either in Common Info or User Info fields to signal request for specific feedback types such as ‘BSR Info Requested’ or 'Delay Feedback Information Requested' or ‘LLI feedback requested’ or ‘Co-TDMA feedback requested’ for example.

From stage 210, where the initiator AP sends the trigger frame, method 200 may advance to stage 220 where a receiving device may send an ICR frame in response to the trigger frame. The ICR frame may be, but is not limited to, a Multi-Station Block Acknowledgement (Multi-STA BA) frame, wherein feedback information is included in the Multi-STA BA in response to the trigger frame comprising the feedback indicator. For example, the receiving device may comprise any one of the plurality of client devices or another AP. The receiving device receiving the trigger frame (e.g., a BSRP (NTB) trigger frame) may then include the feedback information (e.g., BSR, Delay Feedback, LLI feedback, Co-TDMA feedback, and/or other feedback) in the Multi-STA BA, based on the information requested in the trigger frame.

In another embodiment, the responding STA (e.g., a non-AP STA or polled AP in case for Co-TDMA) may determine when to send BSR and/or Delay Feedback in the Multi-STA BA, based on its queue state/conditions, while considering the request received from the initiator AP. In one case, the responding STA may always include BSR in the Multi-STA BA response, and may only include delay feedback based on its Transmit (Tx) queue condition (e.g., when expiry deadline is nearing for MPDUs in the queue) and/or request from the AP.

In one embodiment, the initiator AP sending the BSRP (NTB) Trigger frame may request for BSR and/or Delay Feedback information or LLI feedback or Co-TDMA feedback for specific Traffic Identifiers (TIDs). This may be signaled either by including a TID bitmap per feature (e.g., a TID Bitmap for BSR and another TID Bitmap for Delay Feedback or LLI feedback or Co-TDMA feedback), or a common TID bitmap for all features, indicating a set of TIDs for which information is requested, or a list of one or more TIDs indicating a set of TIDs for which information is requested. As described above, this may be signaled in the Common Information field or User Information fields.

Consistent with embodiments of the disclosure, a UHR variant of the BSRP (NTB) Trigger frame may be defined that includes a 'Trigger Dependent User Info field' that may include fields related to a specific request from the initiator AP. This may be included in a request for BSR and/or Delay Feedback or LLI feedback or Co-TDMA feedback and/or list of TIDs or a TID Bitmap indicating TIDs for which feedback information is requested. This information may also be defined to be carried in a 'Trigger Dependent Common Info field' when the information applies across all the STAs included in the BSRP Trigger frame.

Once the receiving device sends the Multi-STA BA in response to the trigger frame in stage 220, method 200 may continue to stage 230 where the initiator AP may receive the feedback information in the Multi-STA BA. For example, embodiments my include a BSRP (NTB) trigger frame signaling enhancement for the initiator AP to explicitly signal to STAs (or to another AP) that it is requesting feedback (e.g., BSR and/or Delay Feedback or LLI feedback or Co-TDMA feedback) in a response (e.g., in a Multi-STA BA). This may enable the initiator AP to receive timely traffic related feedback for it to perform, for example, more effective UL scheduling or TxOP sharing (e.g., in the case of Co-TDMA). Once the initiator AP receives the feedback information in the Multi-STA BA in stage 230, method 200 may then end at stage 240.

### BSRP Enhancement to Request Low-Latency Indication (LLI) Feedback

A feature may be defined where a STA as a TxOP responder may signal its Low-Latency Indication (LLI) needs in an Initial Control Response (ICR) frame (e.g., in a Multi-STA BA frame). The LLI feedback in a Multi-STA BA may be used by a STA to signal whether it has any urgent Low-Latency (LL) traffic that needs to be served.

A STA may signal its LLI needs in an ICR on its own without being requested by an AP. However, a STA may not be required to signal LLI needs always. For example, a STA may choose to not signal LLI if its LL needs are not imminent (e.g., the STA can tolerate 10ms latency). Also, if a STA does not have any urgent LL traffic, it may not need to provide any LLI to the AP.

In some cases, the AP may want to explicitly know if STAs have LL needs (or not) to better schedule STAs for UL triggering. In such cases, the AP as a TxOP holder should be able to explicitly request one or more STAs to signal its LLI to the AP, perhaps along with BSR information.

Embodiments of the disclosure may enhance a BSRP (NTB) Trigger frame to allow an AP to request that the responding STA (a non-AP STA or a polled AP in Co-TDMA) provides LLI needs (if any) in the ICR frame (e.g., in the Multi-STA BA frame) by including an LLI feedback.

### Signaling Enhancements

In an ICF (e.g., a BSRP (NTB) trigger frame), an AP may indicate the type of one or more feedback information it is requesting from the responding STA using a field in the ICF. This may include requesting BSR information, delay feedback information which indicates expiry deadline (or expiry time or real-time delay feedback or expiry imminence) information for traffic/MPDUs queued in the transmit queus, Low-Latency Indication information, DUO information, Co-TDMA feedback information or any other types of feedback. The Co-TDMA feedback information may provide details of polled AP’s request for the TxOP sharing and may include information such as polled AP’s interest in receiving the portion of TxOP, set of TIDs which need to be served by the polled AP, the time duration which is requested by the polled AP for TxOP sharing based on queued traffic at the polled AP etc. The set of one or more feedback requested (e.g., in the ICR) may be indicated using a bitmap in the ICF where each bit indicates a specific type of feedback requested. For such signaling reserved bits may be used either in Common Info or User Info fields in the BSRP (NTB) trigger frame (or another control frame) to indicate the set of feedback requested by the initiating AP, or new fields may be defined in a User Information field to signal the set of feedback requested.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing BSRP trigger enhancement to query specific feedback as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
sending, by an initiator Access Point (AP), a trigger frame wherein the trigger frame comprises a feedback indicator;
sending, by a receiving device, a Multi-Station Block Acknowledgement (Multi-STA BA) frame in response to the trigger frame wherein feedback information is included in the Multi-STA BA frame in response to the trigger frame comprising the feedback indicator; and
receiving, by the initiator AP, the feedback information in the Multi-STA BA frame.

2. The method of claim 1, wherein the trigger frame comprises a Buffer Status Report Pole (BSRP) trigger frame.

3. The method of claim 1, wherein the trigger frame comprises a Buffer Status Report Pole (BSRP) Non-Trigger Based (NTB) trigger frame.

4. The method of claim 1, wherein the feedback indicator signals a type of feedback information requested comprising at least one of Buffer Status Report (BSR), delay feedback, Low-Latency Indication (LLI) feedback, and Coordinated Time Division Multiple Access (Co-TDMA) feedback.

5. The method of claim 1, wherein the feedback information comprises Buffer Status Report (BSR) information associated with the receiving device.

6. The method of claim 1, wherein the feedback information comprises delay feedback information associated with the receiving device.

7. The method of claim 1, wherein the feedback information comprises Low-Latency Indication (LLI) feedback information associated with the receiving device.

8. The method of claim 1, wherein the feedback information comprises Dynamic Unavailability Operation (DUO) feedback information associated with the receiving device.

9. The method of claim 1, wherein the receiving device comprises a client device.

10. The method of claim 1, wherein the receiving device comprises another AP.

11. The method of claim 1, wherein the feedback indicator is signaled in a Common Information field in the trigger frame.

12. The method of claim 1, wherein the feedback indicator is signaled in a User Information field in the trigger frame.

13. The method of claim 1, wherein the feedback indicator indicates feedback is requested for specific Traffic Identifiers (TIDs).

14. A method comprising:
receiving, by a receiving device from an initiator Access Point (AP), a trigger frame wherein the trigger frame comprises a feedback indicator; and
sending, by the receiving device, a Multi-Station Block Acknowledge (Multi-STA BA) in response to the trigger frame wherein feedback information is included in the Multi-STA BA in response to the trigger frame comprising the feedback indicator.

15. The method of claim 14, wherein the feedback information comprises at least one of Buffer Status Report (BSR) information associated with the receiving device, delay feedback information associated with the receiving device, Low-Latency Indication (LLI) information associated with the receiving device, Dynamic Unavailability Operation (DUO) information associated with the receiving device.

16. The method of claim 14, wherein the trigger frame comprises a Buffer Status Report Pole (BSRP) trigger frame.

17. The method of claim 14, wherein the trigger frame comprises a Buffer Status Report Pole (BSRP) Non-Trigger Based (NTB) trigger frame.

18. A method comprising:
sending, by an initiator Access Point (AP), a trigger frame wherein the trigger frame comprises a feedback indicator; and
receiving, by the initiator from a receiving device, a Multi-Station Block Acknowledge (Multi-STA BA) in response to the trigger frame wherein feedback information is included in the Multi-STA BA in response to the trigger frame comprising the feedback indicator.

19. The method of claim 18, wherein the feedback information comprises at least one of Buffer Status Report (BSR) information associated with the receiving device, delay feedback information associated with the receiving device, Low-Latency Indication (LLI) information associated with the receiving device, Dynamic Unavailability Operation (DUO) information associated with the receiving device.

20. The method of claim 18, wherein the trigger frame comprises one of a Buffer Status Report Pole (BSRP) trigger frame and a Buffer Status Report Pole (BSRP) Non-Trigger Based (NTB) trigger frame.
